(19) United States
(12) Patent Application Publication
(10) Pub. No.: US 2025/0372290 A1
(43) Pub. Date: Dec. 4, 2025

(54) MAGNETIC ARRAY SUPPORT STRUCTURE

(71) Applicant: Honeywell International Inc., Charlotte, NC (US)

(72) Inventors: Jason C. Smoke, Phoenix, AZ (US); Peter Cameron, Ottawa (CA)

(21) Appl. No.: 19/074,185

(22) Filed: Mar. 7, 2025

Related U.S. Application Data
(60) Provisional application No. 63/652,518, filed on May 28, 2024.

(51) Int. Cl. H01F 7/02; G02B 26/00; G02B 26/08

(52) U.S. Cl. CPC H01F 7/0221; G02B 26/004; G02B 26/0816; H01F 7/021

(57) ABSTRACT

An example ferrofluidic mirror includes a reflector support configured to retain a ferrofluid and the ferrofluid disposed within the reflector support. The ferrofluidic mirror also includes a support structure configured to retain a plurality of magnet positioning assemblies in an array, the support structure being configured to position the plurality of magnet positioning assemblies a predetermined distance from the ferrofluid within the reflector support. The ferrofluidic mirror also includes the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies. The ferrofluidic mirror also includes a plurality of magnets, each magnet retained by a respective magnet positioning assembly.

### CROSS-REFERENCE TO RELATED APPLICATIONS

This application claims the benefit of U.S. Provisional Patent Application 63/652,518, filed 28 May 2024, the entire content of which is incorporated herein by reference.

### GOVERNMENT RIGHTS

This invention was made with Government support under FA237724CB011 awarded by DARPA. The Government has certain rights in the invention.

### TECHNICAL FIELD

The present disclosure relates to magnetic arrays and techniques for making an array of magnets, such as for ferrofluidic reflectors.

### BACKGROUND

Mirrors for telescopes are typically made using solid materials which can be polished such as glass, metal, or ceramic and coated with reflective thin films. This approach becomes increasingly expensive with increasing mirror diameter, and increasingly susceptible to damage (e.g., by contact with debris) with increasing mirror diameter.

### SUMMARY

In general, the disclosure describes a support structure for precisely positioning a plurality of magnets in an array and methods of positioning the plurality of magnets using the support structure. In some examples, the support structure includes a plurality of removable, replaceable, and/or repositionable magnet positioning assemblies each comprising a stem, a head, and a retainer strap. The stem and head are configured to position a magnet relative to a surface of the support structure when attached to the support structure, and the retainer strap is configured to hold a magnet in place on the head. In some examples, the stem may be configured to be attached to the support structure, e.g., to have threads so as to attach the stem to the support structure via a nut. The stem may also be configured to be removably attached to a removable assembly rod by which the stem may be manipulated to move the stem into a desired position relative to the support structure and to hold the stem in position while attaching the stem to the support structure in the desired position, e.g., in the presence of a large number of neighboring magnets assembled in an array in the support structure and resulting large magnetic force.

In some examples, the support structure may be configured to be attached to a reflector support. The reflector support may be configured to house a liquid mirror, e.g., one or more liquids and reflective materials, such as a ferrofluid, reflective particles or nanoparticles, and/or one more ionic and/or polar liquids. The support structure and magnet positioning assemblies may be configured to position and retain a plurality of magnets so as to provide a magnetic field that causes the ferrofluidic liquid to form a shape, e.g., a shaped surface, with a sufficient surface quality to be used as a reflector, such as a large (e.g., greater than or equal to 0.5 meter diameter) primary mirror of a telescope. In some examples, the support structure may be adjustably attached to the reflector support, e.g., via one or more actuators configured to tip and/or tilt the reflector support relative to the support structure. For example, when slewing and/or changing the elevation angle of a telescope including the support structure and reflector support, the actuators may be configured to tip and/or tilt the support structure relative to the mirror support to compensate for gravitational effects on the ferrofluidic mirror by changing the position of the ferrofluid in the mirror support relative to the magnetic field from the magnets of the support structure.

Aspects of this disclosure may provide one or more technical advantages and solve one or more technical problems. Aspects of this disclosure may provide for improved primary mirror optical performance by providing a magnetic field with an improved uniformity. For example, aspects of this disclosure may provide for a support structure configured to position a plurality of magnet positioning assemblies in an array, and the plurality of magnet positioning assemblies are configured to enable fine tuning of positioning of each individual magnet of the plurality of magnets when in the array. The support structure and magnet positioning assemblies may provide fine tuning adjustments to compensate for variation in the magnetic properties of the individual magnets of the array.

Additionally, aspects of this disclosure may provide for improved assembly of large ferrofluidic mirrors using a large array of magnets (e.g., greater than 100 magnets, or greater than 1000 magnets, or greater than 2,500 magnets). The magnets may be relatively powerful permanent magnets (e.g., neodymium magnets), such that precision aligning each individual magnet becomes difficult due to the large magnetic force of the large number of neighboring powerful permanent magnets. Aspects of this disclosure may provide for a support structure and magnet positioning assemblies configured to allow a removable assembly rod to be used to control positioning of each magnet in the presence of a large magnetic force.

As one example, a ferrofluidic mirror includes: a reflector support configured to retain a ferrofluid; the ferrofluid disposed within the reflector support; a support structure configured to retain a plurality of magnet positioning assemblies in an array, wherein the support structure is configured to position the plurality of magnet positioning assemblies a predetermined distance from the ferrofluid within the reflector support; the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies; and a plurality of magnets, each magnet retained by a respective magnet positioning assembly.

As another example, a ferrofluidic mirror magnet assembly includes: a support structure configured to retain a plurality of magnet positioning assemblies in an array, the support comprising a first surface and a second surface opposing the first surface, wherein the support structure is configured to position the plurality of magnet positioning assemblies a predetermined distance from the ferrofluid within the reflector support; the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies; and a plurality of magnets, each magnet retained by a respective magnet positioning assembly.

As another example, a method of forming a ferrofluidic mirror magnet assembly includes: attaching a magnet to a magnet positioning assembly, the magnet positioning assembly includes a head configured to support a magnet at a proximal end of the magnet positioning assembly; a stem extending distally from the head; retainer strap configured to retain the magnet against the head; and the magnet retained to the head by the retainer strap; attaching a removable assembly rod to the magnet positioning assembly; inserting the removable assembly rod through a through hole of a plurality of regularly spaced through holes of a support structure, wherein the support structure is configured to retain a plurality of magnet positioning assemblies in an array, wherein the support structure is configured to position the plurality of magnet positioning assemblies a predetermined distance from a ferrofluid within a reflector support, wherein the support structure comprises a first surface and a second surface opposing the first surface and defines the plurality of regularly spaced through holes between the first surface and the second surface; inserting, using the removable assembly rod, the stem of the magnet positioning assembly through the through hole until the head is adjacent to the first surface and the stem extends from the second surface; attaching, via a nut engaging with external threads along a distal portion of the stem, the magnet positioning assembly to the support structure; and removing the removable assembly rod.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic perspective view of an example reflector.

FIG. 2 is a cross-sectional and perspective view of the example reflector of FIG. 1.

FIG. 3 is a magnified cross-sectional and perspective view of a portion of the example reflector of FIG. 2.

FIG. 4 is a perspective view of an example actuator of reflector of FIG. 1.

FIG. 5A is a perspective view of an example magnet positioning assembly.

FIG. 5B is a perspective cross-sectional view of the example magnet positioning assembly of FIG. 5A.

FIG. 6 is a flow diagram illustrating an example technique of forming a ferrofluidic mirror magnet assembly

### DETAILED DESCRIPTION

A conventional reflector for an optical telescope is typically a solid piece of material, such as glass, quartz, ceramic, or metal, which may be machined to extremely tight tolerances, polished to extreme smoothness, and covered with special reflective and/or durability enhancing coatings. Special machinery exists within the optics industry to achieve the necessary precision and accuracy for small-to-medium sized reflectors at a reasonable cost, however, for large (e.g., greater than or equal to 0.5 meter (m) diameter) reflectors, the cost and time required to produce a reflector of sufficient quality may be exponentially higher, if not altogether prohibitive. Additionally, periodic maintenance and refurbishing of the reflective surface may be required during the service life of the reflector, which may also be costly and time consuming.

A ferrofluidic reflector may be less costly to produce and maintain with sufficient reflective characteristics, e.g., surface roughness, over a large diameter. A ferrofluidic reflector may also be lighter and easier and faster to move, e.g., to slew and/or change elevation angle. A ferrofluid mirror may comprise a relatively thin, e.g., 1-3 millimeter (mm) layer of fluid including magnetic particles retained within a reflector support, which may be a shaped dish, e.g., a dish with a spherical, parabolic, or any other suitable shape. The reflector support may be positioned proximate to (e.g., attached atop of) one or more magnets, or an array of a plurality magnets, such as a Halbach array of magnets. Magnetic particles may be mixed into, and suspended within, the fluid layer. The magnetic field of the magnets positioned proximate the reflector support may cause the magnetic particles to conform to a shape, e.g., the shape of an outer surface of the reflector support, irrespective of gravitational and/or inertial forces.

In some examples, the fluid and/or the magnetic particles may be reflective, e.g., substantially reflective for visible light, infrared light, ultraviolet light, or any suitable wavelength band of electromagnetic radiation. In some examples, the ferrofluid mirror may comprise reflectors, e.g., a reflective fluid and/or a plurality of reflective particles, the reflectors being substantially reflective for visible light, infrared light, ultraviolet light, or any suitable wavelength band of electromagnetic radiation. In some examples the reflectors may comprises a relatively thin, e.g., 0.1-0.2 mm) reflective fluid layer comprising reflective particles on top of, e.g., as the outermost layer of, the ferrofluidic reflector, e.g., such that light is incident on the reflective fluid layer first. In other examples, the reflective fluid layer may form within the ferrofluid, e.g., suspended with the ferrofluid, or may form at the bottom, e.g., adjacent to the outer surface of the reflector support, of the ferrofluid.

In some examples, the reflective fluid layer may form an outer reflective surface having substantially high optical quality and surface quality (e.g., sub-wavelength peak-to-valley surface variation), which may enable the outer surface of the reflector support to be made with less precision that what is normally required for optical surfaces. The manufacture of components may then be much less expensive and time-consuming.

In some examples, a Halbach array of magnets for a ferrofluidic reflector may include a substantially large number of substantially powerful magnets, e.g., greater than or equal to 100 neodymium (Nd) permanent magnets, to be held in close proximity to one another, e.g., less than or equal to 5 mm gap between magnets, and with magnetic pole directions of adjacent magnets that are orthogonal to one another. For example, the array may include powerful magnets arranged such that the magnets have strong inter-magnetic repulsive forces for which precisely positioning each magnet within the array may be difficult.

In accordance with the devices and methods described herein, a support structure and a plurality of magnet positioning assemblies are configured to precisely position and hold a plurality of magnets in an array (e.g., a Halbach array) in spite of strong inter-magnetic forces. In some examples, the magnet positioning assembly may include a stem, a head, and a retainer, e.g., a pedestal and retainer strap, for each individual magnet. The stem and retainer configured to securely retain the magnet and enable improved installation and/or attachment, and positioning, of the magnet relative to the support structure, e.g., without complex tooling. In some examples, the support structure may include an arrangement of actuators configured to adjust tip and tilt of the support structure relative to the reflector support. In some examples, the actuators may comprise piezo-electric actuators, lead-screw actuators, or any suitable actuators configured to provide precise control of the position and orientation of the reflector support relative to the support structure and the array of magnets, and which may be configured to adjust and/or maintain alignment of the reflective surface (e.g., the reflective fluid) via the ferrofluid at varying telescope altitudes as well as during telescope slewing.

In some examples, the support structure and magnet positioning assembly are configured to form a ferrofluidic mirror shape (e.g., focusing shape) via positioning of the plurality of magnets relative to the reflector support and a ferrofluid retained within the reflector support. For example, the outer surface of the reflector support may have a generally focusing shape, e.g., a spherical shape, a paraboloidal shape, or any suitable focusing shape, and the support structure and magnet positioning assembly may be configured to position the array of magnets such that the resultant magnetic fields of the magnets cause the ferrofluid to form a shape causing the reflective fluid to form a focusing shape with optical-quality surface characteristics, e.g., sub-wavelength peak-to-valley surface roughness.

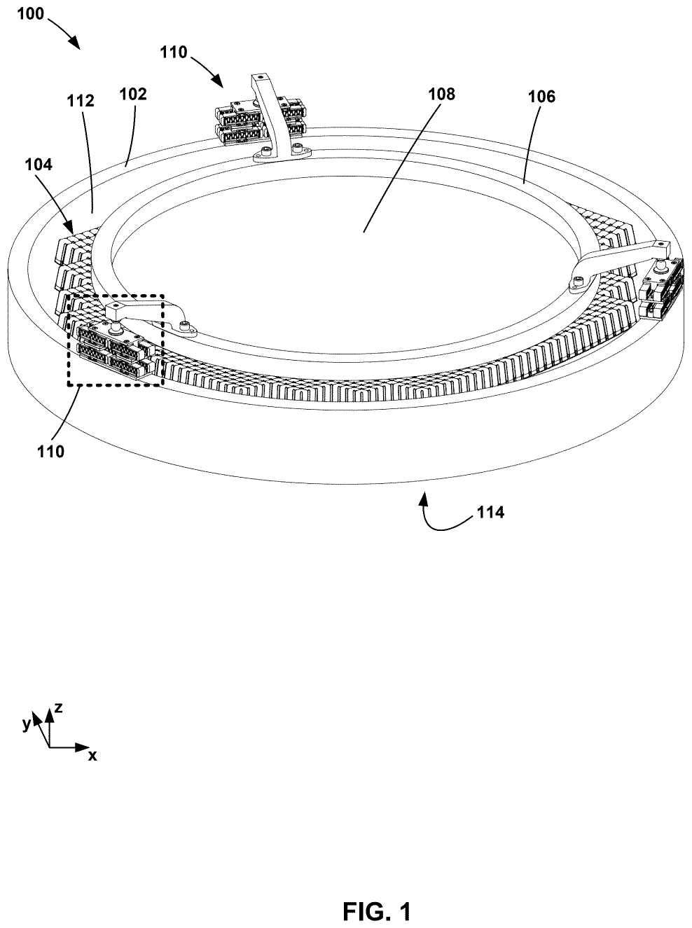

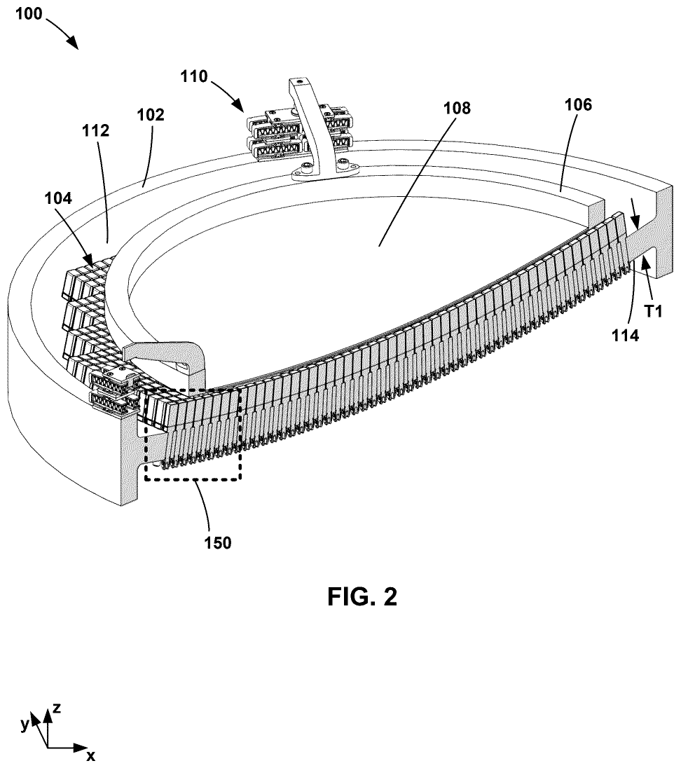

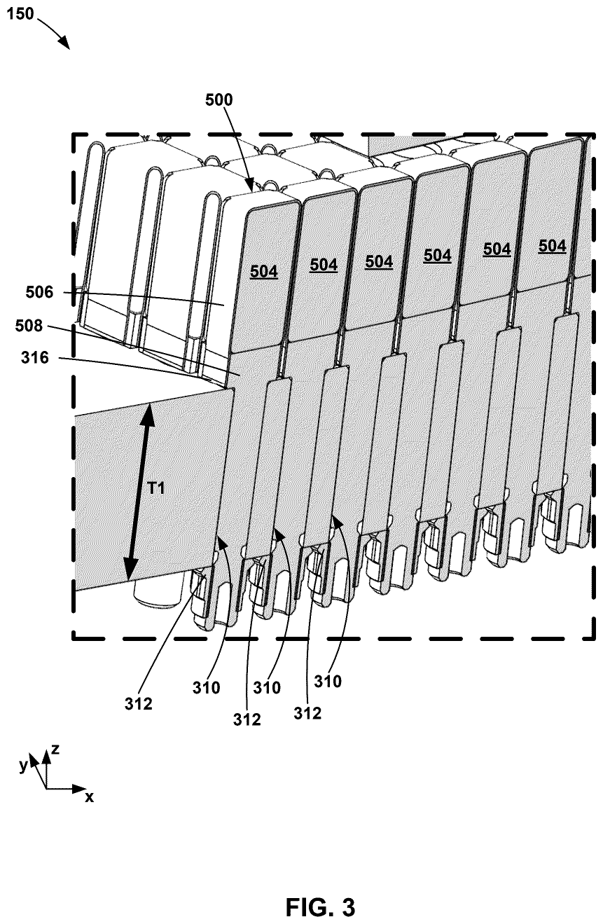

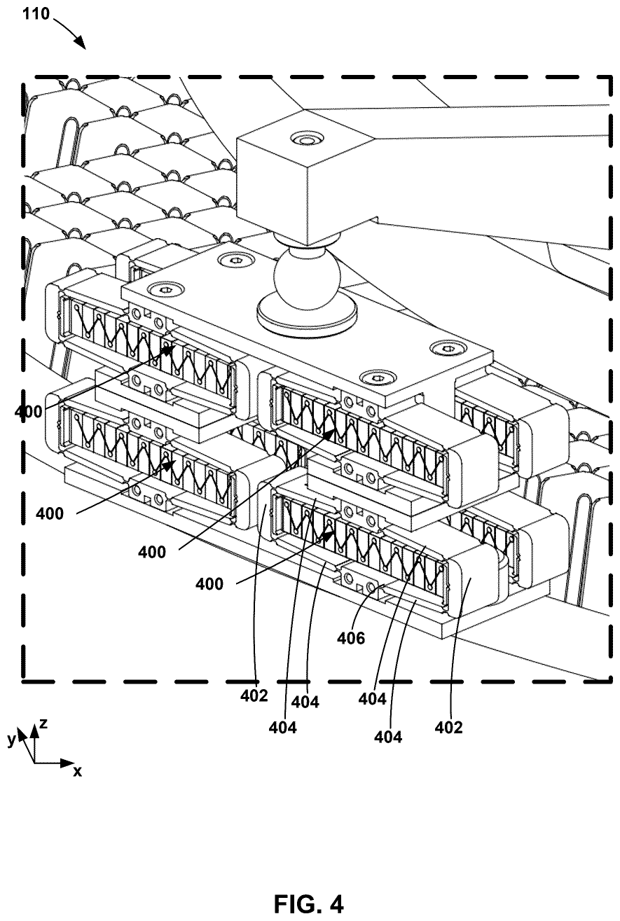

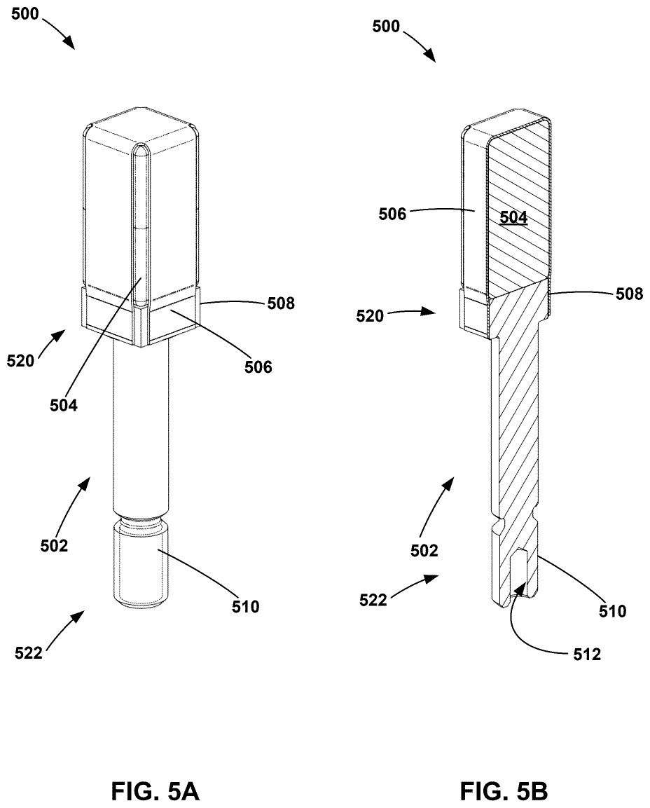

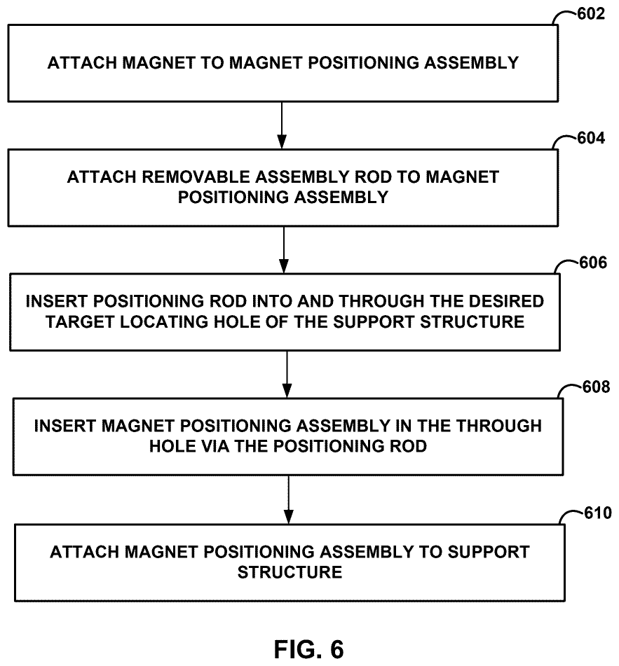

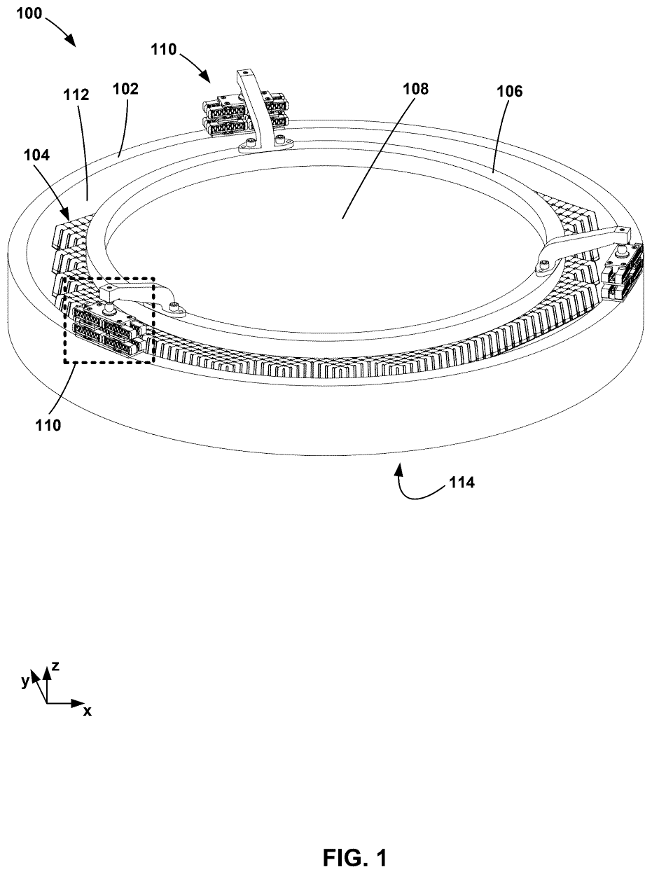

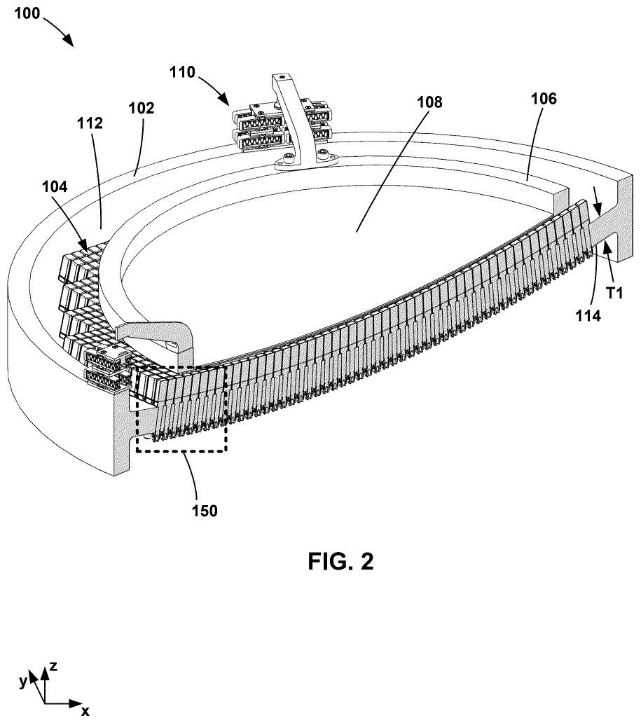

FIG. 1 is a schematic perspective view of an example ferrofluidic mirror 100. In the example shown, ferrofluidic mirror 100 includes support structure 102, reflector support 106, and actuators 110. FIG. 2 is a cross-sectional and perspective view of the example ferrofluidic mirror 100 of FIG. 1. FIGS. 1-2 are described together below. In the examples shown, support structure 102 includes magnet array 104, and reflector support 106 includes reflective ferrofluid 108.

Support structure 102 may be comprised of a nonmagnetic material, such as aluminum, brass, titanium, or the like, and may be sufficiently stiff so as to hold magnet array 104 in position relative to reflector support 106. In some examples, support structure 102 may have a first surface 112 facing reflector support 106 (e.g., a top surface) and a second opposing (e.g., bottom) surface 114, with a thickness T1 (FIG. 2) of material between the first and second surfaces 112, 114, e.g., in a direction perpendicular to the first and second surfaces 112, 114. First surface 112 may have a shape, e.g., a concave shape with respect to the positive z-direction. For example, first surface 112 may have a spherical, paraboloidal, or any suitable shape, to within typical machining tolerances. In some examples, second surface 114 may follow the shape of first surface 112, or may be flat, or may have any suitable shape. Thickness T1 may be constant as a function of x-y position along first and second surfaces 112, 114, e.g., for first and second surfaces 112, 114 having the same shape, or thickness T1 may vary as a function of x-y position along first and second surfaces 112, 114, e.g., for first and second surfaces 112, 114 having different shapes. For example, second surface 114 may be flat, and first surface 112 may have a concave shape. In the examples shown, second surface 114 is curved having a convex shape (e.g., because second surface 114 is facing the negative z-direction) matching a concave shape of first surface 114 that is a focusing shape intended for a reflector or reflecting surface of ferrofluidic mirror 100, such that T1 is substantially constant.

In the example shown, support structure 102 and reflector support 106 are configured to provide the overall focusing shape of ferrofluidic mirror 100, and the reflective ferrofluid 108 is configured to provide the optical-quality reflective surface of ferrofluidic mirror 100, e.g., a reflective surface having a subwavelength wavefront error due to deviation from an ideal reflective surface shape (e.g., an idea flat, spherical, conical and/or aspherical surface shape). For example, support structure 102, reflector support 106, and reflective ferrofluid may be configured to provide a reflective surface having a wavefront error of less than or equal to λ/2, or less than or equal to λ/10, or less than or equal to λ/100, or any suitable surface quality surface flatness, where λ is a wavelength of light used for testing, e.g., a visible light wavelength, which may be about 550 nanometers.

In the example shown, reflector support 106 is configured to retain ferrofluid 108. Reflector support 106 may have a surface having a shape that is substantially the same as first surface 112 of support structure 102, e.g., a concave focusing shape. Reflector support 106 may be configured to be positioned and oriented relative to first surface 112 of support structure 102 such that a magnetic field of magnet array 104 supported by support structure 102 causes ferrofluid 108 to form the optical-quality focusing shape. In some examples, ferrofluidic mirror 100 may be a large primary mirror, e.g., having a diameter of the reflecting surface that is equal to or greater than 0.5 meters, or equal to or greater than 1 meter, or equal to or greater than 5 meters, or equal to or greater than 10 meters or more. Support structure 102, reflector support 106, and magnet array 104 may be sized and include a plurality of magnets sufficient for a large primary mirror. For example, magnet array 104 may include a large number of permanent magnets, e.g., equal to or greater than 100 magnets, or equal to or greater than 500 magnets, or equal to or greater than 1,000 magnets, or equal to or greater than 2,500 magnets, or equal to or greater than 5,000 magnets, or equal to or greater than 10,000 magnets or more.

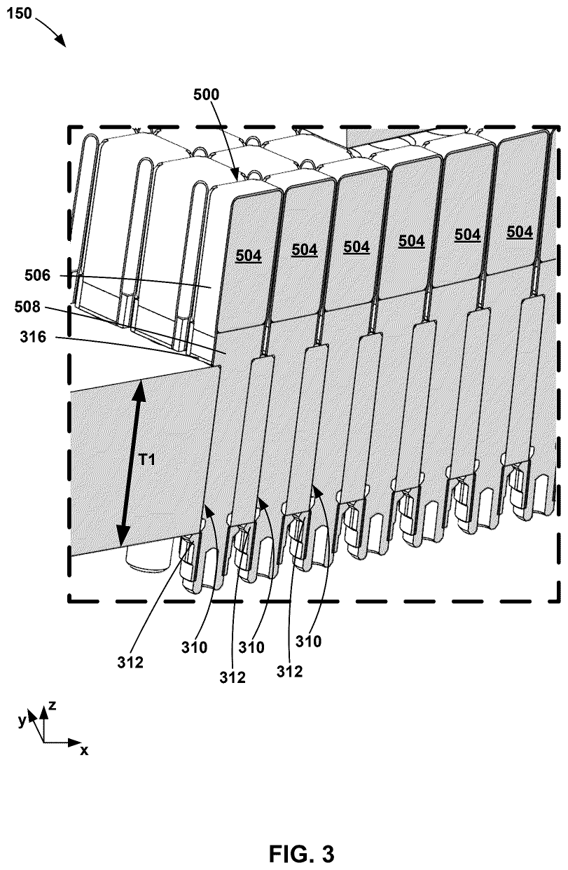

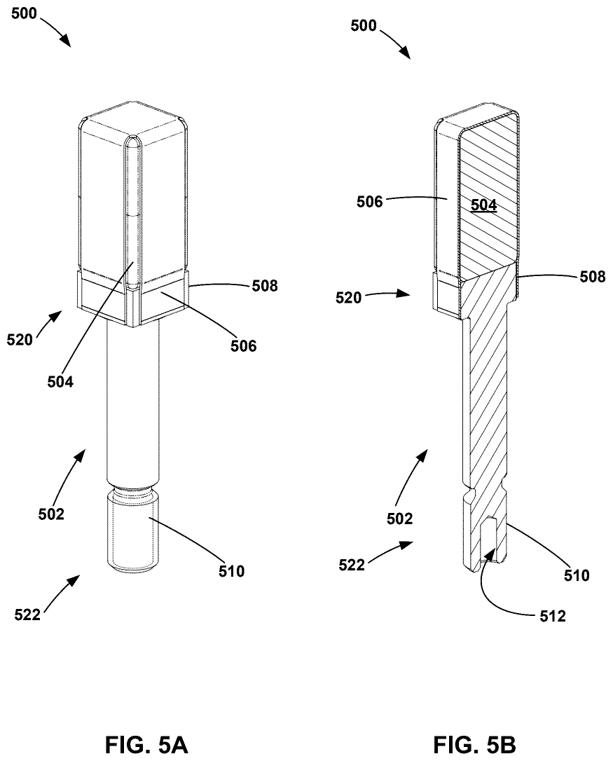

Support structure 102 may be configured to retain a plurality of magnet positioning assemblies 500 including magnets 504 (FIG. 5) in an array, e.g., to form magnet array 104. Support structure 102 may be configured to position the plurality of magnet positioning assemblies 500 a predetermined distance from ferrofluid 108 within reflector support 106. For example, support structure 102 may define a plurality of locating holes 310 (FIG. 3). Locating holes 310 may be through holes through the thickness T1 of support structure 102 from the first surface 112 to the second surface 114, and locating holes 310 may be positioned in an array, e.g., regularly spaces in the x- and y-directions in the examples shown. Each locating hole 310 may be sized and configured to receive at least a portion of a magnet positioning assembly 500 (FIGS. 5A-5B).

For example, each locating hole 310 may be sized such that a portion of stem 502 of a magnet positioning assembly 500 may be press fit and/or slid through the locating hole 310 until head 508 of the magnet positioning assembly 500 is adjacent to first surface 112. In some examples, a magnet positioning assembly 500 may be press fit and/or slid through the locating hole 310 until head 508 contacts first surface 112, and in some examples, a magnet positioning assembly 500 may be press fit and/or slid through the locating hole 310 until head 508 contacts a separator, such as a shim, positioned between first surface 112 and head 508, e.g., so as to fine tune the z-direction position of head 508 and magnet 504 supported by the magnet positioning assembly 500, as further described below. The positions of locating holes 310 in the x-y directions may determine the x-y separation between adjacent magnet positioning assemblies 500 and magnets 504, e.g., the array of locating holes 310 of support structure 102 may determine the x-y positions (and partially determine z-direction positions to the extent first surface 112 has a shape) of the magnet array 104.

In the example shown, a plurality of magnet positioning assemblies 500 are positioned within locating holes 310 of support structure 102 to form the magnet array 104. In the example shown, each magnet positioning assembly 500 is configured to retain a magnet 504 at a position within support structure 102 at a predetermined distance from neighboring magnets 504 withing neighboring magnet positioning assemblies 500 of the plurality of magnet positioning assemblies, e.g., of magnet array 104. In some examples, each magnet positioning assembly 500 includes a magnet 504 having magnetic poles oriented relative to neighboring magnets 504 such that magnet array 104 forms a predetermined magnetic field as a function of x-, y-, and z-position, e.g., to form a Halbach magnet array 104.

Actuators 110 may be configured to tip and/or tilt support structure 102 relative to reflector support 106, e.g., with a high degree of precision. In the example shown, ferrofluidic mirror 100 includes three actuators 110, although in other examples, ferrofluidic mirror 100 may include more or fewer actuators 110, e.g., one, two, or four or more actuators 110. In the example shown, actuators 110 are equally spaced about the perimeters of support structure 102 and reflector support 106. In other examples, actuators 110 may be unequally spaced about support structure 102 and reflector support 106, or positioned anywhere (along, within, or outside of the perimeters of support structure 102 and reflector support 106) so as to be able to tip and/or tilt support structure 102 relative to reflector support 106. In the example shown, actuators 110 are configured to increase or decrease the z-distance gap between support structure 102 and reflector support 106 at the perimeter positions shown in order to tip/tilt support structure 102 relative to reflector support 106.

FIG. 3 is a magnified cross-sectional and perspective view of a portion 150 of the example ferrofluidic mirror 100 of FIG. 2. In the example shown, magnet positioning assemblies 500 and magnets 504 (FIGS. 5A and 5B) are closely packed, e.g., with retainer straps 506 in contact or with a predetermined, small gap between the outer surfaces of retainer straps 506. For example, the positions and/or x-y spacings of locating holes 310 may be configured to determine the x-y spacings between magnets 504 retained within magnet positioning assemblies 500. Locating holes 310 and magnet positioning assemblies 500 may be configured to position magnets 504 such that there are gaps between the outer surfaces of neighboring magnets 504 that are less than or equal to about 10 millimeters (mm), or less than or equal to about 2 mm, or less than or equal to about 1 mm, or less than or equal to about 0.5 mm, or any suitable gap distance.

In some examples, ferrofluidic mirror 100 may include one or more shims 316 placed between head 508 of magnet positioning assembly 500 and the first surface 112, e.g., the shim 316 configured to raise (perpendicularly from first surface 112 and substantially in the positive z-direction) the position magnet positioning assembly 500 and magnet 504 relative to support structure 102 so as to correct for variations in sizes of support structure 102, magnet positioning assembly 500, head 508, magnet 504, or variation in magnetic fields caused by magnet 504. For example, each shim of a plurality of shims may have a thickness that may be the same as, or different from, one or more other shims of the plurality of shims and that may be configured to reduce a nonuniformity of the magnetic field at the ferrofluid 108.

Support structure 102 and magnet positioning assemblies 500 may be configured to reduce and/or eliminate deflection of magnets 504 during, and after, arrangement of magnets 504 in magnet array 104, and to position magnet array 104 to create a substantially uniform magnetic field on reflective ferrofluid 108. In some examples, magnet array 104 may include greater than or equal to 100 magnet positioning assemblies 500 and magnets 504, or greater than or equal to 500 magnet positioning assemblies 500 and magnets 504, or greater than or equal to 1,000 magnet positioning assemblies 500 and magnets 504, greater than or equal to 2,500 magnet positioning assemblies 500 and magnets 504, greater than or equal to 5,000 magnet positioning assemblies 500 and magnets 504, greater than or equal to 10,000 magnet positioning assemblies 500 and magnets 504, or any suitable number of magnet positioning assemblies 500 and magnets 504.

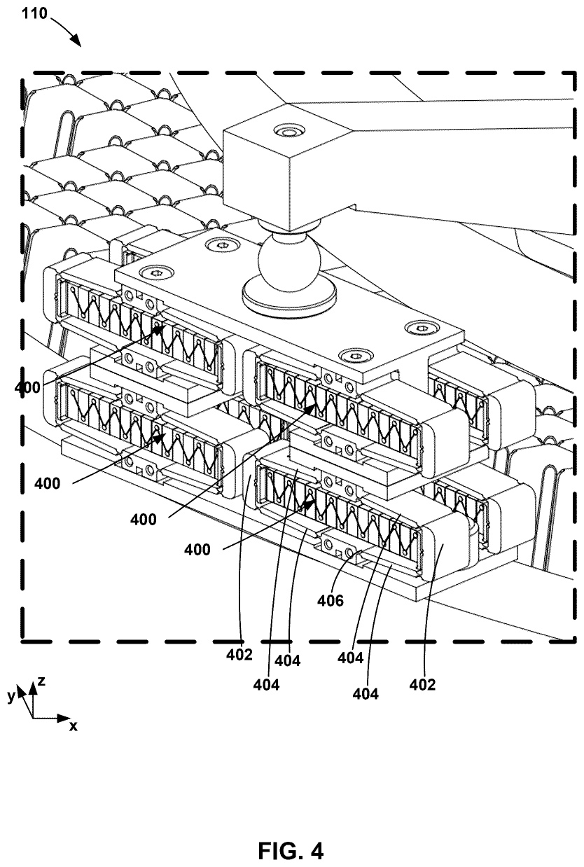

FIG. 4 is a perspective view of an example actuator 110 of ferrofluidic mirror 100 of FIG. 1. In the example shown, actuator 110 includes a plurality of piezoelectric actuator stacks 400 configured to laterally move actuator walls 402 connected to actuator top and bottom plates 404 via hinged sections 406. For example, lateral movement (e.g., in a direction substantially within the x-y plane as shown) of the actuator walls 402 by piezoelectric actuator stacks 400 cause the top and bottom plates 404 to move vertically, e.g., substantially in the z-direction. In the example shown, actuator 110 includes the plurality of piezoelectric actuator stacks 400 arranged in series (e.g., in the z-direction), which may improve the dynamic range of movement in the z-direction, and in parallel (e.g., in a direction in the x-y plane), which may improve load capacity. In some examples, actuators 110 may be configured to tip and tilt reflector support 106 relative to support structure 102, e.g., to compensate for magnetic fields and/or forces, or other forces, and/or during slewing of ferrofluidic mirror 100.

FIG. 5A is a perspective view of an example magnet positioning assembly 500, and FIG. 5B is a perspective cross-sectional view of the example magnet positioning assembly 500 of FIG. 5A. In the examples shown, magnet positioning assembly 500 includes stem 502, head 508, and retainer strap 506. Stem 502 is configured to fit within locating holes 310 of support structure 102, and head 508 is configured to support magnet 504 at a proximate end 520 of magnet positioning assembly 500. Head 508 may also be configured to position magnet 504 a predetermined distance in a direction perpendicular to first surface 112 when head 508 is in contact with first surface 112 or shim 316. In the example shown, stem 502 extends distally from head 508, and may be attached to, or integrally formed with, head 508.

In some examples, stem 502 may include a threaded stem portion 510. For example, threaded stem portion 510 may comprise a distal length of a distal portion 522 of stem 502 comprising external threads, e.g., a threaded external surface of stem 502. Threaded stem portion 510 may be configured to engage with nut 312 (FIG. 3), e.g., such that nut 312 may be threaded onto threaded stem portion 510 and tightened against second surface 114 to secure magnet positioning assembly 500 to support structure 102. For example, the threads of threaded stem portion 510 may be on an external surface of stem 502 for a portion of the length of stem 502.

Retainer strap 506 may be configured to retain magnet 504 against head 508, and in the example shown, magnet 504 is secured to head 508 by retainer strap 506. For example, retainer strap 506 may be folded about magnet 504 on top and on one or more side or perimeter position (e.g., magnets 504 may be rectangular, cylindrical, or any suitable shape). In the example shown, retainer strap 506 includes four flaps that wrap over the top of magnet 504 and down the sides of magnet 504 to vertical faces of head 508. Retainer strap 506 may be attached to head 508. For example, retainer strap 506 may be attached to head 508 to retain magnet 504 against head 508. In some examples, retainer strap 506 may be attached to head 508 via welding such as ultrasonic welding, brazing, an adhesive, a fastener, or any suitable attachment method. Retainer strap 506 may be thin, e.g., about 16 thousandths of an inch or about 0.4 mm in thickness.

In some examples, stem 502 may be hollow for at least a portion of its distal length. For example, stem 502 may define a recess extending proximally from the distal end of stem 502 for a distance along stem 502. Stem 502 may also include internal threads 512 within at least a portion of the recess, e.g., for a portion of the length of the recess within stem 502. The internal threads may be configured to engage with a removable assembly rod (not shown) that may include threads configured to be threaded into stem 502 to attach the removable assembly rod to stem 502, e.g., extending from the distal end of stem 502 and magnet positioning assembly 500.

In some examples, the removable assembly rod may be attached to stem 502 before magnet positioning assembly 500 in assembled into support structure 102. The rod may be manipulated, e.g., by a user or a robotic means, to pull stem 502 through a through hole 310 into its final position in a controlled manner, e.g., to prevent magnet positioning assembly 500 from rapidly accelerating (e.g., via magnetic forces from other magnets 504) into first surface 112 or other magnet positioning assemblies 500 that are already in place. For example, through holes 310 may be configured to receive the removable assembly rod therethrough while the removable assembly rod is attached to magnet positioning assembly 500. Magnet positioning assembly 500 may then be secured to support structure 102 via nut 312, and the removable assembly rod may then be removed. For example, thickness T1 of support structure 102 between first surface 112 and second surface 114 may be such that a portion of stem 502 extends from second surface 114 and such that head 508 of magnet positioning assembly 500 is adjacent to first surface 112. Magnet positioning assembly 500, stem 502, head 508, retainer strap 506, nut 312, and the removable assembly rod may all be made of a nonmagnetic material, e.g., aluminum, brass, titanium, or any suitable nonmagnetic material.

As described above, ferrofluidic mirror 100 may be a large primary mirror. In the examples shown in FIGS. 1-5B, the concave shape of first surface 112 of support structure 102, the regularly spaced through holes 310, and the plurality of magnet positioning assemblies 500 are configured to position the plurality of magnets 504 to form a magnetic field at the ferrofluid 108 configured to induce a concave and light focusing surface shape of the ferrofluid 108 having a diameter of greater than or equal to 0.5 meters and a surface flatness wavefront error of less than or equal to λ/2, or less than or equal to λ/10, or less than or equal to λ/100, or any suitable optical-quality surface flatness. In some examples, reflector support 106, support structure 102, and the plurality of magnet positioning assemblies 500 (excepting for magnets 504) comprise a nonmagnetic material comprising at least one of aluminum, brass, or titanium.

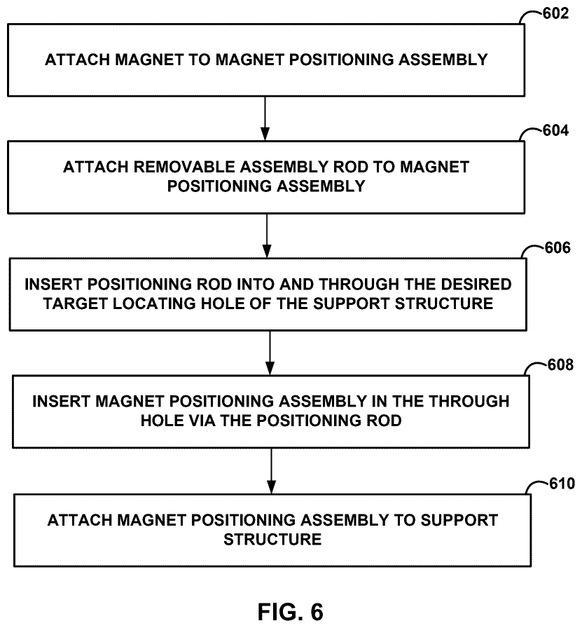

FIG. 6 is a flow diagram illustrating an example technique of forming a ferrofluidic mirror magnet assembly. FIG. 6 is described with reference to ferrofluidic mirror 100 FIGS. 1-5B. However, the techniques of FIG. 6 may be utilized to make different ferrofluidic mirrors and/or additional or optical systems.

An operator may attach a magnet 504 to magnet positioning assembly 500 (602). For example, a person or machine may position magnet 504 onto head 508, secure the magnet 504 to the head via retainer strap 506, and attach the retainer strap 506 to the head 508. In some examples, the operator may ultrasonically weld retainer strap 506 to a surface of head 508 to retain magnet 504 to head 508.

The operator may attach a removable assembly rod to magnet positioning assembly 500 (604). For example, the operator may thread the positioning rod into stem 502. The operator may then insert the removable assembly rod into and through a through hole 310 of a plurality of regularly spaced through holes 310 of support structure 102 (606). The operator may then insert, using the removable assembly rod, stem 502 of magnet positioning assembly 500 through the through hole 310 until head 508 is adjacent to first surface 112 and stem 502 extends from second surface 114 (608). For example, the operator may control insertion of magnet positioning assembly 500 in locating hole 310 via the positioning rod, and the operator may move magnet positioning assembly 500 into position within locating hole 310 while preventing magnet positioning assembly 500 from rapidly accelerating due to magnetic forces from other magnets 504 attached to support structure 102. The operator may then attach magnet positioning assembly 500 to support structure 102, e.g., via nut 312 engaging with external threads along a distal portion 522 of stem 502 (610). In some examples, the operator may shim magnet positioning assembly 500 by positioning a shim 316 between head 508 and first surface 112 of support structure 102, e.g., a shim 316 comprising a thickness configured to reduce a nonuniformity of the magnetic field at the ferrofluid 108.

Select examples of the present disclosure include, but are not limited to, the following examples.

Example 1: A ferrofluidic mirror includes: a reflector support configured to retain a ferrofluid; the ferrofluid disposed within the reflector support; a support structure configured to retain a plurality of magnet positioning assemblies in an array, wherein the support structure is configured to position the plurality of magnet positioning assemblies a predetermined distance from the ferrofluid within the reflector support; the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies; and a plurality of magnets, each magnet retained by a respective magnet positioning assembly.

Example 2: The ferrofluidic mirror of example 1, wherein each magnet positioning assembly of the plurality of magnet positioning assemblies includes: a head configured to support the magnet at a proximal end of the magnet positioning assembly; a stem extending distally from the head; and retainer strap configured to retain the magnet against the head.

Example 3: The ferrofluidic mirror of example 2, wherein the retainer strap is ultrasonically welded to the head to retain the magnet against the head.

Example 4: The ferrofluidic mirror of example 2 or example 3, wherein a first distal length of the stem includes external threads configured to engage with a nut, wherein a second distal length of the stem defines a recess within the stem, wherein the stem includes internal threads within at least a portion of the recess, wherein the internal threads are configured to engage with a removable assembly rod to attach the removable assembly rod to the stem extending from a distal end of the magnet positioning assembly.

Example 5: The ferrofluidic mirror of example 4, wherein the support structure includes a first surface and a second surface opposing the first surface and defines a plurality of regularly spaced through holes between the first surface and the second surface, wherein each through hole configured to receive the stem of a magnet positioning assembly of the plurality of magnet positioning assemblies and is configured to receive the removable assembly rod therethrough while the removable assembly rod is attached to the magnet positioning assembly, wherein a thickness of the support structure between the first surface and the second surface is such that a portion of the stem extends from the second surface and such that the head of the magnet positioning assembly is adjacent to the first surface, wherein the nut may engage the external threads to attach the magnet positioning assembly to the support structure.

Example 6: The ferrofluidic mirror of example 5, where the first surface includes a concave shape.

Example 7: The ferrofluidic mirror of example 6, wherein the concave shape of the first surface of the support structure, the regularly spaced through holes, and the plurality of magnet positioning assemblies are configured to position the plurality of magnets to form a magnetic field at the ferrofluid configured to induce a concave and light focusing surface shape of the ferrofluid having a diameter of greater than or equal to 0.5 meters and a surface flatness wavefront error of less than or equal to 22.

Example 8: The ferrofluidic mirror of example 7, further including a plurality of shims, each shim positioned between the head of a corresponding magnet positioning assembly of the plurality of magnet positioning assemblies and the first surface of the support structure, wherein the shim includes a thickness configured to reduce a nonuniformity of the magnetic field at the ferrofluid.

Example 9: The ferrofluidic mirror of any one of examples 1-8, wherein the reflector support, the support structure, and the plurality of magnet positioning assemblies include a nonmagnetic material including at least one of aluminum, brass, or titanium.

Example 10: The ferrofluidic mirror of any one of examples 1-9, further including a plurality of actuators configured to tip and tilt the reflector support relative to the support structure.

Example 11: A ferrofluidic mirror magnet assembly includes: a support structure configured to retain a plurality of magnet positioning assemblies in an array, the support including a first surface and a second surface opposing the first surface, wherein the support structure is configured to position the plurality of magnet positioning assemblies a predetermined distance from a ferrofluid within a reflector support; the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies; and a plurality of magnets, each magnet retained by a respective magnet positioning assembly.

Example 12: The ferrofluidic mirror magnet assembly of example 11, wherein each magnet positioning assembly of the plurality of magnet positioning assemblies includes: a head configured to support the magnet at a proximal end of the magnet positioning assembly; a stem extending distally from the head; and retainer strap configured to retain the magnet against the head.

Example 13: The ferrofluidic mirror magnet assembly of example 12, wherein the retainer strap is ultrasonically welded to the head to retain the magnet against the head.

Example 14: The ferrofluidic mirror magnet assembly of example 12 or example 13, wherein a first distal length of the stem includes external threads configured to engage with a nut, wherein a second distal length of the stem defines a recess within the stem, wherein the stem includes internal threads within at least a portion of the recess, wherein the internal threads are configured to engage with a removable assembly rod to attach the removable assembly rod to the stem extending from a distal end of the magnet positioning assembly.

Example 15: The ferrofluidic mirror magnet assembly of example 14, wherein the support structure includes a first surface and a second surface opposing the first surface and defines a plurality of regularly spaced through holes between the first surface and the second surface, wherein each through hole configured to receive the stem of a magnet positioning assembly of the plurality of magnet positioning assemblies and is configured to receive the removable assembly rod therethrough while the removable assembly rod is attached to the magnet positioning assembly, wherein a thickness of the support structure between the first surface and the second surface is such that a portion of the stem extends from the second surface and such that the head of the magnet positioning assembly is adjacent to the first surface, wherein the nut may engage the external threads to attach the magnet positioning assembly to the support structure.

Example 16: The ferrofluidic mirror magnet assembly of example 15, where the first surface includes a concave shape.

Example 17: The ferrofluidic mirror magnet assembly of example 16, wherein the concave shape of the first surface of the support structure, the regularly spaced through holes, and the plurality of magnet positioning assemblies are configured to position the plurality of magnets to form a magnetic field at the ferrofluid configured to induce a concave and light focusing surface shape of the ferrofluid having a diameter of greater than or equal to 0.5 meters and a surface flatness wavefront error of less than or equal to ½.

Example 18: The ferrofluidic mirror magnet assembly of example 17, further including a plurality of shims, each shim positioned between the head of a corresponding magnet positioning assembly of the plurality of magnet positioning assemblies and the first surface of the support structure, wherein the shim includes a thickness configured to reduce a nonuniformity of the magnetic field at the ferrofluid.

Example 19: The ferrofluidic mirror magnet assembly of any one of examples 11-18, wherein the support structure, and the plurality of magnet positioning assemblies include a nonmagnetic material including at least one of aluminum, brass, or titanium.

Example 20: A method of forming a ferrofluidic mirror magnet assembly includes attaching a magnet to a magnet positioning assembly, the magnet positioning assembly includes a head configured to support a magnet at a proximal end of the magnet positioning assembly; a stem extending distally from the head; retainer strap configured to retain the magnet against the head; and the magnet retained to the head by the retainer strap; attaching a removable assembly rod to the magnet positioning assembly; inserting the removable assembly rod through a through hole of a plurality of regularly spaced through holes of a support structure, wherein the support structure is configured to retain a plurality of magnet positioning assemblies in an array, wherein the support structure is configured to position the plurality of magnet positioning assemblies a predetermined distance from a ferrofluid within a reflector support, wherein the support structure includes a first surface and a second surface opposing the first surface and defines the plurality of regularly spaced through holes between the first surface and the second surface; inserting, using the removable assembly rod, the stem of the magnet positioning assembly through the through hole until the head is adjacent to the first surface and the stem extends from the second surface; attaching, via a nut engaging with external threads along a distal portion of the stem, the magnet positioning assembly to the support structure; and removing the removable assembly rod.

Example 21: The method of example 20, further includes shimming the magnet positioning assembly by positioning a shim between the head and the first surface of the support structure, wherein the shim includes a thickness configured to reduce a nonuniformity of the magnetic field at the ferrofluid.

Various examples have been described. These and other examples are within the scope of the following claims.

What is claimed is:

1. A ferrofluidic mirror comprising:
a reflector support configured to retain a ferrofluid;
the ferrofluid disposed within the reflector support;
a support structure configured to retain a plurality of magnet positioning assemblies in an array, wherein the support structure is configured to position the plurality of magnet positioning assemblies a predetermined distance from the ferrofluid within the reflector support;
the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies; and
a plurality of magnets, each magnet retained by a respective magnet positioning assembly.

2. The ferrofluidic mirror of claim 1, wherein each magnet positioning assembly of the plurality of magnet positioning assemblies comprises:
a head configured to support the magnet at a proximal end of the magnet positioning assembly;
a stem extending distally from the head; and
retainer strap configured to retain the magnet against the head.

3. The ferrofluidic mirror of claim 2, wherein the retainer strap is ultrasonically welded to the head to retain the magnet against the head.

4. The ferrofluidic mirror of claim 2, wherein a first distal length of the stem comprises external threads configured to engage with a nut, wherein a second distal length of the stem defines a recess within the stem, wherein the stem comprises internal threads within at least a portion of the recess, wherein the internal threads are configured to engage with a removable assembly rod to attach the removable assembly rod to the stem extending from a distal end of the magnet positioning assembly.

5. The ferrofluidic mirror of claim 4, wherein the support structure comprises a first surface and a second surface opposing the first surface and defines a plurality of regularly spaced through holes between the first surface and the second surface,
wherein each through hole configured to receive the stem of a magnet positioning assembly of the plurality of magnet positioning assemblies and is configured to receive the removable assembly rod therethrough while the removable assembly rod is attached to the magnet positioning assembly,
wherein a thickness of the support structure between the first surface and the second surface is such that a portion of the stem extends from the second surface and such that the head of the magnet positioning assembly is adjacent to the first surface,
wherein the nut may engage the external threads to attach the magnet positioning assembly to the support structure.

6. The ferrofluidic mirror of claim 5, where the first surface comprises a concave shape.

7. The ferrofluidic mirror of claim 6, wherein the concave shape of the first surface of the support structure, the regularly spaced through holes, and the plurality of magnet positioning assemblies are configured to position the plurality of magnets to form a magnetic field at the ferrofluid configured to induce a concave and light focusing surface shape of the ferrofluid having a diameter of greater than or equal to 0.5 meters and a wavefront error of less than or equal to λ/2.

8. The ferrofluidic mirror of claim 7, further comprising a plurality of shims, each shim positioned between the head of a corresponding magnet positioning assembly of the plurality of magnet positioning assemblies and the first surface of the support structure, wherein the shim comprises a thickness configured to reduce a nonuniformity of the magnetic field at the ferrofluid.

9. The ferrofluidic mirror of claim 1, wherein the reflector support, the support structure, and the plurality of magnet positioning assemblies comprise a nonmagnetic material comprising at least one of aluminum, brass, or titanium.

10. The ferrofluidic mirror of claim 1, further comprising a plurality of actuators configured to tip and tilt the reflector support relative to the support structure.

11. A ferrofluidic mirror magnet assembly comprising:
a support structure configured to retain a plurality of magnet positioning assemblies in an array,
the support comprising a first surface and a second surface opposing the first surface,
wherein the support structure is configured to position the plurality of magnet positioning assemblies a predetermined distance from a ferrofluid within a reflector support;
the plurality of magnet positioning assemblies, each magnet positioning assembly configured to retain a magnet at a position within the support structure at a predetermined distance from neighboring magnets within neighboring magnet positioning assemblies of the plurality of magnet positioning assemblies; and
a plurality of magnets, each magnet retained by a respective magnet positioning assembly.

12. The ferrofluidic mirror magnet assembly of claim 11, wherein each magnet positioning assembly of the plurality of magnet positioning assemblies comprises:
a head configured to support the magnet at a proximal end of the magnet positioning assembly;
a stem extending distally from the head; and
retainer strap configured to retain the magnet against the head.

13. The ferrofluidic mirror magnet assembly of claim 12, wherein the retainer strap is ultrasonically welded to the head to retain the magnet against the head.

14. The ferrofluidic mirror magnet assembly of claim 12, wherein a first distal length of the stem comprises external threads configured to engage with a nut, wherein a second distal length of the stem defines a recess within the stem, wherein the stem comprises internal threads within at least a portion of the recess, wherein the internal threads are configured to engage with a removable assembly rod to attach the removable assembly rod to the stem extending from a distal end of the magnet positioning assembly.

15. The ferrofluidic mirror magnet assembly of claim 14, wherein the support structure comprises a first surface and a second surface opposing the first surface and defines a plurality of regularly spaced through holes between the first surface and the second surface,
wherein each through hole configured to receive the stem of a magnet positioning assembly of the plurality of magnet positioning assemblies and is configured to receive the removable assembly rod therethrough while the removable assembly rod is attached to the magnet positioning assembly,
wherein a thickness of the support structure between the first surface and the second surface is such that a portion of the stem extends from the second surface and such that the head of the magnet positioning assembly is adjacent to the first surface,
wherein the nut may engage the external threads to attach the magnet positioning assembly to the support structure.

16. The ferrofluidic mirror magnet assembly of claim 15, where the first surface comprises a concave shape.

17. The ferrofluidic mirror magnet assembly of claim 16, further comprising a plurality of shims, each shim positioned between the head of a corresponding magnet positioning assembly of the plurality of magnet positioning assemblies and the first surface of the support structure, wherein the shim comprises a thickness configured to reduce a nonuniformity of the magnetic field at the ferrofluid.

18. The ferrofluidic mirror magnet assembly of claim 11, wherein the support structure, and the plurality of magnet positioning assemblies comprise a nonmagnetic material comprising at least one of aluminum, brass, or titanium.

19. A method of forming a ferrofluidic mirror magnet assembly, the method comprising:
attaching a magnet to a magnet positioning assembly, the magnet positioning assembly comprising:
a head configured to support a magnet at a proximal end of the magnet positioning assembly;
a stem extending distally from the head;
retainer strap configured to retain the magnet against the head; and
the magnet retained to the head by the retainer strap;
attaching a removable assembly rod to the magnet positioning assembly;
inserting the removable assembly rod through a through hole of a plurality of regularly spaced through holes of a support structure,
wherein the support structure is configured to retain a plurality of magnet positioning assemblies in an array,
wherein the support structure is configured to position the plurality of magnet positioning assemblies a predetermined distance from a ferrofluid within a reflector support, wherein the support structure comprises a first surface and a second surface opposing the first surface and defines the plurality of regularly spaced through holes between the first surface and the second surface;
inserting, using the removable assembly rod, the stem of the magnet positioning assembly through the through hole until the head is adjacent to the first surface and the stem extends from the second surface;
attaching, via a nut engaging with external threads along a distal portion of the stem, the magnet positioning assembly to the support structure; and
removing the removable assembly rod.

20. The method of claim 19, further comprising:
shimming the magnet positioning assembly by positioning a shim between the head and the first surface of the support structure, wherein the shim comprises a thickness configured to reduce a nonuniformity of a magnetic field at the ferrofluid.
